(19) United States
(12) Patent Application Publication
(10) Pub. No.: US 2010/0025451 A1
(43) Pub. Date: Feb. 4, 2010

(54) GAS COMBUSTION TYPE DRIVING TOOL

(76) Inventor: Hiroshi Tanaka, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 12/527,276

(22) PCT Filed: Feb. 14, 2008
(86) PCT No.: PCT/JP2008/052449

§ 371 Date: Aug. 14, 2009

(30) Foreign Application Priority Data
Feb. 15, 2007 (JP) 2007-035087

(51) Int. Cl. B25C 1/08

(52) U.S. Cl. 227/9

(57) ABSTRACT

A gas combustion type driving tool is provided with a combustion chamber; an electric motor; a rotary fan connected to a shaft of the electric motor for stirring and mixing a combustible gas and air within the combustion chamber; an accommodating portion formed in a wall of the combustion chamber for accommodating the electric motor; a shaft inserting tubular portion which is formed in the accommodating portion and through which the shaft of the electric motor penetrates; and a seal member interposed between an inner surface of the shaft inserting tubular portion and the electric motor.

### TECHNICAL FIELD

The present invention relates to a gas combustion type driving tool structured such that, within a combustion chamber formed upwardly of a striking cylinder, a combustible gas and air are stirred and mixed together using a rotary fan driven by an electric motor to thereby produce a mixed gas, the thus produced mixed gas is then ignited and combusted, and a pressure of a combustion gas produced by a combustion is used to drive a striking piston accommodated within the striking cylinder to thereby drive a faster such as a nail. Specifically, the invention relates to a gas combustion type driving tool which can protect the electric motor for driving the rotary fan against an impact of the mixed gas when it is combusted.

### BACKGROUND ART

As an example of such gas combustion type driving tool, there is known a combustion gas driving machine. In this combustion gas driving machine, a combustible gas is charged into a closed combustion chamber. Within the combustion chamber, a combustible gas and air are stirred and mixed up together to thereby produce a mixed gas. As the stirred and mixed gas is combusted within the combustion chamber, there is generated a high pressure combustion gas within the combustion chamber. As the high pressure combustion gas is applied to a striking piston accommodated within a striking cylinder, the striking piston is impactively driven within the striking cylinder. Thus, a nail is driven into a steel plate or a concrete by a driver which is connected to the lower surface side of the striking piston. Such combustion gas driving machine can be structured in the following manner: that is, a container such as a gas cylinder filled with a combustible gas is mounted into the driving machine, and a battery serving as a power source for igniting the combustible gas is mounted into the driving machine, whereby the driving machine is produced as a portable tool. Therefore, a nail or a pin can be driven free from a power supply source such as electric power or compressed air.

As described above, in the above combustion gas driving machine, there is provided a rotary fan for stirring and mixing together the combustible gas injected into the combustion chamber and the air existing within the combustion chamber to thereby produce a mixed gas having a given air-gas ratio. The rotary fan can be rotated by an electric motor. The electric motor for rotating the rotary fan is accommodated into an accommodating portion formed in a cylinder head which is located in an upper portion of the combustion chamber. A shaft, which is projected from the electric motor, projects into the combustion chamber through a shaft receiving hole formed in a bottom portion of the accommodating portion.

However, in an operation of the combustion gas driving tool, when the mixed gas existing within the combustion chamber is ignited and exploded, the cylinder head is moved upwardly due to the combustion pressure of the mixed gas, whereas a force of inertia is applied to the electric motor. Therefore, the electric motor is moved downwardly relative to the cylinder head. Also, when the striking piston driven by the combustion pressure impactively strikes against a bumper provided on a lower portion of the striking cylinder, the cylinder head is also moved downwardly together with a main body of the tool, whereas the inertial force is applied to the electric motor. Therefore, the electric motor is moved upwardly relative to the cylinder head. In this manner, the electric motor is vibrated within the tool main body due to an acceleration that is applied thereto when the striking piston reciprocatingly moves. As a result, a welding portion between the electric motor and other composing part may be broken or a bearing can be damaged: that is, the vibrating electric motor has a great influence on a reliability and life of the tool.

In order to solve this problem, as disclosed in the patent reference 1, there is known an electric motor protection mechanism in which the outer peripheral surface of the electric motor and the inner wall of the accommodating portion are held through a buffer member made of rubber (see the patent reference 1). Since the electric motor is structured such that it is held by the elastic buffer member, even when vertical vibrations are applied to the electric motor, the impacts can be prevented from being applied to the electric motor itself. This can protect the electric motor against the vertical impacts.

In addition, there is also known an electric motor protection mechanism in which, when the electric motor is accommodated into the accommodating portion formed in the upper portion of the combustion chamber, short-tube-shaped elastic buffer members are respectively provided in the upper and lower portions of the electric motor, whereby, when the driving tool is in operation, impacts or vibrations to be applied to the electric motor for driving the rotary fan in the vertical direction can be relieved effectively to thereby enhance the durability and reliability of the electric motor (see the patent reference 2).

Patent Reference 1: JP-A-2004-130506

Patent Reference 2: JP-A-2006-281398

However, since the above-mentioned technology provides a structure in which the pressure of the combustion gas entering through a clearance intervening between an inserting tubular portion and a shaft is received by a whole of side surfaces of a housing of the electric motor on a combustion chamber side, a load corresponding to “an outside diameter of the electric motor×a pressure of the combustion gas” provides a load to be applied to the electric motor. Especially, since the striking piston strikes impactively against the bumper just after the mixed gas existing within the combustion chamber is combusted, the buffer member in the upper portion of the electric motor, just after it is bent by the combustion pressure, receives the impacts in the striking time before the bending deformation thereof is returned; and, therefore, the buffer member is unable to absorb the impacts in the striking time. That is, the above-mentioned buffer member is found insufficient to solve the problem.

Also, recently, in order to increase an output of the combustion gas, there has been carried out an operation to supercharge the air into the combustion chamber. This also urges a development of a mechanism for protection of the electric motor.

### SUMMARY OF INVENTION

One or more embodiments of the invention provided a gas combustion type driving tool which effectively relieves impacts of a pressure of a combustion gas during operation applied to an electric motor for driving a rotary fan, to thereby be able to enhance a durability and a reliability of the electric motor.

According to a first aspect of the invention, in a gas combustion type driving tool structured such that: in a wall of a combustion chamber, there is formed an accommodating portion for accommodating an electric motor therein; a shaft of the electric motor is penetrated through a shaft inserting tubular portion of the accommodating portion and is connected to a rotary fan which is disposed to face the combustion chamber; within the combustion chamber, a combustible gas and the air are stirred and mixed by the rotary fan to produce a mixed gas, and the thus produced mixed gas is ignited and combusted; and, a pressure of a combustion gas generated by such combustion is used to drive a fastener such as a nail, a seal member is interposed between the inner surface of the shaft inserting tubular portion of the accommodating portion and the above-mentioned electric motor, and a pressure of the combustion gas entering into a clearance intervening between the inserting tubular portion and shaft is received by the inside of the seal member.

According to a second aspect of the invention, in the driving tool according to the first aspect, a sealing portion on the electric motor side to be sealed by the seal member may also be provided in the shaft bearing portion of the electric motor.

According to a third aspect of the invention, in the driving tool according to the first aspect, a sealing portion on the electric motor side to be sealed by the seal member may also be provided in a side surface on a combustion chamber side of the electric motor.

According to one or more embodiments of the invention, since the seal member is interposed between the inner surface of the shaft inserting tubular portion of the accommodating portion and electric motor, and also since the pressure of the combustion gas entering into the clearance intervening between the inserting tubular portion and shaft is received by the inside of the seal member, the pressure of the combustion gas is applied only to the periphery of the shaft that is a very limited range, whereby the impact load to be applied to the electric motor is small. Therefore, when the driving tool is in operation, the impacts to be applied to the electric motor for driving the rotary fan can be relieved effectively by the pressure of the combustion gas to protect the electric motor positively, thereby being able to enhance the durability and reliability of the electric motor.

Other aspects and advantages of the invention will be apparent from the following description, the drawings and the claims.

### BRIEF DESCRIPTION OF DRAWINGS

FIG. 1 is a longitudinal section view of main portions of a gas combustion type nailing machine.

FIG. 2 is a partially enlarged section view of a combustion chamber formed in the gas combustion type nailing machine.

FIG. 3 is a section of the main portions of the gas combustion type nailing machine, showing another embodiment of a seal portion of a seal member on the electric motor side.

### DESCRIPTION OF REFERENCE NUMERALS

11: Combustion chamber
18: Rotary fan
20: Electric motor
21: Shaft
22: Accommodating portion
25, 26: Buffer member
30, 31: O ring (seal member)

### DESCRIPTION OF EMBODIMENTS

Embodiments of the invention are described with reference to accompanying drawings.

### Embodiment 1

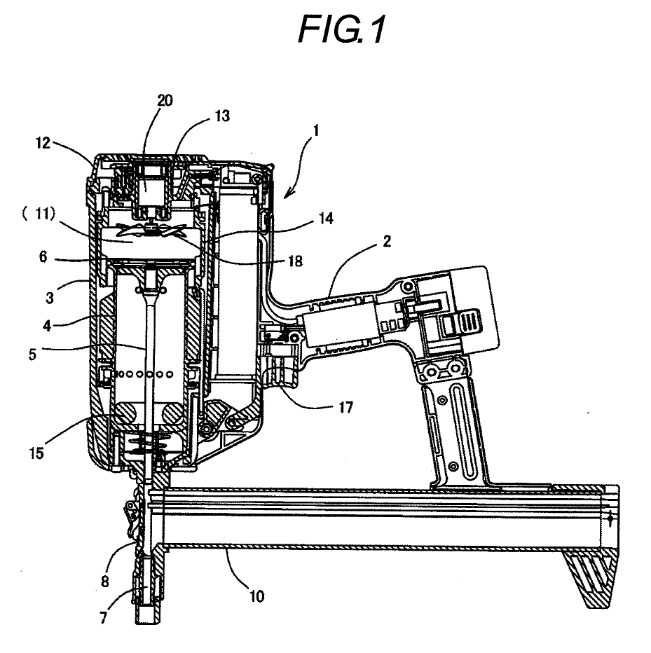

In FIG. 1, reference numeral 1 designates a gas combustion type nailing machine. In the gas combustion type nailing machine 1, there is disposed a striking cylinder 4 within a housing 3 which includes a grip 2 formed integrally therewith. A striking piston 6 including a driver 5 for driving a nail is accommodated within the striking cylinder 4, while the striking piston 6 is allowed to slide in a vertical direction. A nose portion 8 having an injection port 7 is formed in the lower portion of the housing 3. A magazine 10 for containing connected nails (not shown) is mounted on a rear side of the nose portion 8. The nails contained within the magazine 10 are sequentially supplied to the injection port 7, and the nails are driven by the driver 5 to be struck out from the injection portion port 7 into a member to be nailed.

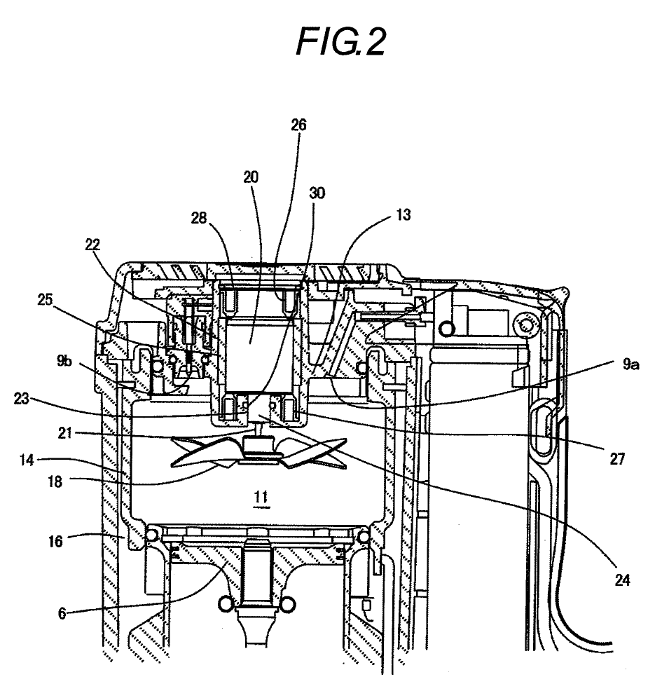

A combustion chamber 11 is formed in an upper side of the striking cylinder 4, and a mixed gas is produced from a combustible gas and the air and the mixed gas is combusted in the combustion chamber 11. The combustion chamber 11 is formed by upwardly moving a ring-shaped movable sleeve 14 which is interposed between an upper end of the striking cylinder 4 to which an upper end face of the striking piston 6 is exposed and an upper wall (cylinder head) 13 formed in an inside of an upper housing 12, as shown in FIG. 2. The pressure of a combustion gas, which is produced by producing a mixed gas from the combustible gas and air and then combusting the mixed gas explosively within the combustion chamber, is applied to the striking piston 6, and the striking piston 6 is moved to a bumper 15 which is disposed at a bottom dead center position within the striking cylinder 4.

The movable sleeve 14 constituting the combustion chamber 11 is disposed slidably along an operation direction of the striking piston 6. Before the nailing machine 1 is started, the movable sleeve 14 is situated at its lower position and allows the inside of the combustion chamber 11 to be in communication with the air through a vent (not shown) formed penetrated through the upper wall 13 and a passage 16 formed between an outer peripheral surface of the striking cylinder 4 and the inner peripheral surface of the housing 3. Also, when starting the nailing machine 1, the nose portion 8 is pressed against the member to be nailed, whereby the movable sleeve 14 is relatively moved upwardly to its upper position shown in FIG. 2 to close the inside of the combustion chamber 11 from the air.

An injection nozzle 9a in communication with a gas container and a spark plug 9b which is used to ignite and combust the mixed gas are provided in the upper housing 12 which forms the upper wall 13 of the combustion chamber 11. The spark plug 9b ignites the mixed gas according to a state of a switch which can be operated by actuating a trigger 17.

A rotary fan 18 which is used to stir and mix a combustible gas injected into the combustion chamber 11 with the air existing in the combustion chamber 11 is provided in the upper housing 12, so as to produce a mixed gas of a given air-fuel ratio within the combustion chamber 11.

The rotary fan 18 is fixed to the leading end of the shaft 21 of an electric motor 20, while the electric motor 20 is accommodated within an accommodating portion 22 formed in the upper wall 13 of the combustion chamber 11.

The accommodating portion 22 is formed in a cylindrical shape. An upper portion of the accommodating portion 22 is opened. A shaft inserting tubular portion 23 directing upward is integrally formed in a central portion of a lower portion of the accommodating portion 22. The electric motor 20 is inserted into the accommodating portion 22 through the upper open portion of the accommodating portion 22. A bearing portion 24 of a shaft 21 of the electric motor 20 is fitted with the tubular portion 23. The shaft 21 penetrates through the tubular portion 23 and projects downwardly of the accommodating portion 22 to rotatably support the rotary fan 18.

A buffering motor sleeve 25 which is made of synthetic resin such as polyacetal resin (POM) is wound on an outer periphery of the electric motor 20. The upper and lower side surfaces of the electric motor 20 are respectively supported by buffer members 26 and 27. The buffer members 26 and 27 are respectively formed in a short tubular shape and are made of elastic material such as silicone-system rubber which is excellent in heat resistance. The upper buffer members 26 and 27 are supported by a pressure member 28.

A seal member is interposed between the inner surface of the shaft inserting tubular portion 23 of the accommodating portion 22 and the above-mentioned electric motor 20. That is, between the inner surface of the tubular portion 23 and the shaft bearing portion 24 of the electric motor 20, there is interposed an O ring (seal member) 30.

In the nail driving operation, when the mixed gas within the combustion chamber 11 is ignited and explosively combusted, the resultant combustion pressure acts onto the upper surface of the striking piston 6 to move the striking piston 6 downwardly. At the same time, a part of the pressure of the combustion gas acts onto the electric motor 20 through a clearance intervening between the inserting tubular portion 23 of the accommodating portion 22 and shaft 21. However, since the ring 30 is interposed between the inner surface of the tubular portion 23 and the above-mentioned shaft bearing 24, the above-mentioned pressure is received by the inside of the O ring 30. That is, since the pressure of the combustion gas simply acts on a very limited range, specifically, the seal portion between the inner surface of the tubular portion 23 and the outside surface of the bearing portion 24, a load (=the area of O ring 30× pressure) to be applied to the electric motor 20 is small. Thus, the bending of the upper buffer member 26 may also be small. Further, when, as the electric motor 20 is impactively moved upwardly, the downwardly driven striking piston 6 strikes impactively against the bumper 15 of the lower portion of the striking cylinder 4, the accommodating portion 22 is also moved suddenly in the downward direction together with the housing 3. However, since the force of inertia is applied to the electric motor 20 and thus the electric motor 20 is impactively moved in the upward direction relative to the accommodating portion 22, the upper buffer member 26 is also bent. In this manner, although, to the upper buffer member 26, there are successively applied the operation pressures that are caused by the upward movement of the electric motor 20, since the amount of bending of the upper buffer member 26 caused by the initial combustion chamber is small, there is room up to the bending limit of the buffer member. Thus, when the striking piston 6 is driven after then, the buffer member can be bent due to the operation pressure caused by the driving of the striking piston 6; that is, the bending of the buffer member can relieve the impacts that are applied to the electric motor 20.

Since, to these impacts, there are added the impacts that are caused by driving a nail into a member to be nailed, the electric motor 20 is vibrated heavily in the vertical direction but the impacts can be absorbed effectively by the upper and lower buffer members 26 and 27. Further, since, when the mixed gas is combusted explosively within the combustion chamber 11, there is generated a hot blast of high temperature and high pressure within the combustion chamber 11, the rotary fan 18 receives such pressure from the lateral direction thereof as vibrates and shakes the rotary fan 18 heavily from various directions perpendicular to the axial direction of the shaft 21. However, the pressure in the lateral direction can be absorbed effectively by the elasticity of the motor sleeve 25.

Therefore, when the driving tool is in operation, impacts applied to the electric motor 20 for driving the rotary fan can be relieved effectively by the pressure of the combustion gas to thereby protect the electric motor 20 positively. Thus, the durability and reliability of the electric motor 20 can be enhanced.

### Embodiment 2

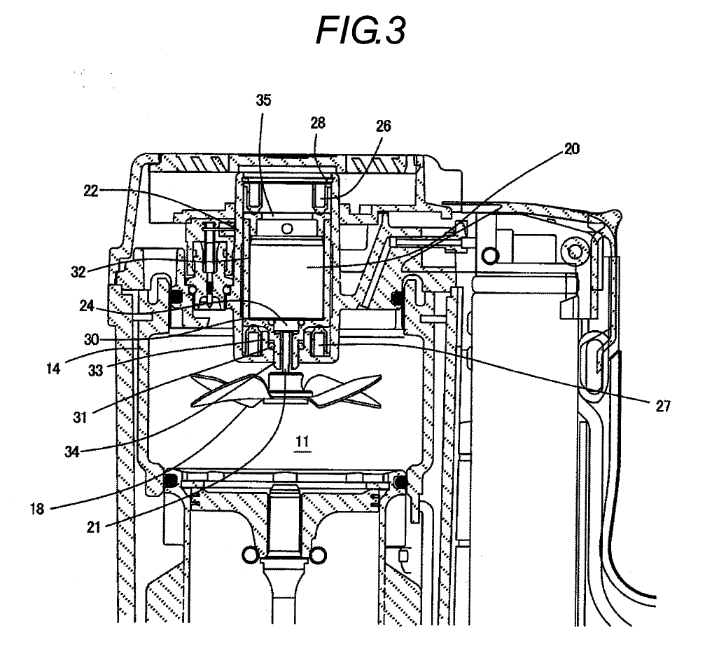

FIG. 3 is a section view of a gas combustion type nailing machine, showing another embodiment of the seal portion on the electric motor 20 side that is sealed by the seal member.

In FIG. 3, the electric motor 20 is accommodated within the accommodating portion 22. The accommodating portion 22 is formed in a cylindrical shape, the upper portion of the accommodating portion 22 is open. A shaft inserting outer tubular portion 33 which is disposed to face upwardly is integrally formed in the central portion of the lower portion of the accommodating portion 22. The electric motor 20 and the outer periphery of the shaft 21 are enclosed by a cover member 32. The upper end of the cover member 32 is open. A shaft inserting inner tubular portion 34 is formed in the lower end of the cover member 32. The shaft 21 of the electric motor 20 and a bearing portion 24 are inserted in the shaft inserting inner tubular portion 34. The shaft inserting inner tubular portion 34 is fitted with the inside of the outer tubular portion 33.

The electric motor 20 is inserted into the accommodating portion 22 and cover member 32 from their respective upper open portions thereof. The bearing portion 24 of the shaft 21 of the electric motor 20 is fitted with the inner tubular portion 34. The shaft 21 penetrates through the tubular portion 23 and projects downwardly of the accommodating portion 22 to thereby rotatably support the rotary fan 18.

The upper and lower side surfaces of the electric motor 20 are respectively supported by buffer members 26 and 27. A ring-shaped member 35 is provided on the upper side surface of the electric motor 20. The upper buffer members 26 and 27 are provided on the ring-shaped member 35. The upper buffer member 26 is supported by a pressure member 28.

An O ring 31 (a second seal member) is provided between the outer tubular portion 33 of the accommodating portion 22 and the inner tubular portion 34 of the cover member 32. An ring 30 (a first seal member) is inserted between the inner surface of the inner tubular portion 34 and the bearing portion 24 of the electric motor 20.

In the nail driving operation, when the mixed gas within the combustion chamber 11 is ignited and explosively combusted, the resultant combustion pressure acts onto the upper surface of the striking piston 6 to move the striking piston 6 downwardly. At the same time, a part of the pressure of the combustion gas acts onto the electric motor 20 through a clearance intervening between the inserting tubular portion 34 of the accommodating portion 22 and shaft 21 and through a clearance between the inner tubular portion 34 and outer tubular portion 33.

The pressure of the combustion gas, which enters into the clearance between the inner tubular portion 34 and shaft 21, is received by the inside of the O ring 30 interposed between the inner surface of the inner tubular portion 34 and the shaft bearing portion 24. The pressure of the combustion gas entering into the clearance between the inner tubular portion 34 and outer tubular portion 33 is also received by the inside of the O ring 30 interposed between the two tubular portions 34 and 33. Therefore, there is no possibility that this combustion pressure can act on the electric motor 20.

That is, since the pressure of the combustion gas simply acts on the very limited range, specifically, the seal portion between the inner surface of the inner tubular portion 34 and the outside surface of the bearing portion 24, a load to be applied to the electric motor 20 is small. Thus, the amount of bending of the upper buffer member 26 may also be small.

Therefore, according to the present embodiment, when the driving tool is in operation, impacts applied to the electric motor 20 for the rotary fan can be relieved effectively by the pressure of the combustion gas, which makes it possible to enhance the durability and reliability of the electric motor 20.

Although the invention has been described heretofore in detail and with reference to the specific embodiments thereof, it is obvious to those skilled in the art that various changes and modifications are also possible without departing from the spirit and scope of the invention.

The present application is based on the Japanese Patent Application (Patent Application No. 2007-035087) filed on Feb. 15, 2007 and the contents thereof are incorporated herein for reference.

### INDUSTRIAL APPLICABILITY

The present invention can be applied to a gas combustion type driving tool which drives a fastener such as a nail using a pressure of a combustion gas produced when a combustible gas is combusted.

1. A gas combustion type driving tool for driving a fastener such as a nail using a pressure of a combustion gas produced by a combustion of a combustible gas, the gas combustion type driving tool comprising:
a combustion chamber;
an electric motor;
a rotary fan connected to a shaft of the electric motor and for stirring and mixing the combustible gas and air within the combustion chamber;
an accommodating portion formed in a wall of the combustion chamber and for accommodating the electric motor therein;
a shaft inserting tubular portion which is formed in the accommodating portion and through which the shaft of the electric motor penetrates; and
a seal member interposed between an inner surface of the shaft inserting tubular portion and the electric motor,
wherein a pressure of the combustion gas entering in a clearance between the shaft inserting tubular portion and shaft is received by the seal member.

2. The gas combustion type driving tool according to claim 1, wherein the seal member is interposed between the inner surface of the shaft inserting tubular portion and a shaft bearing portion of the electric motor.

3. The gas combustion type driving tool according to claim 1, wherein the seal member is in contact with a side surface of the electric motor on a combustion chamber side.

4. The gas combustion type driving tool according to claim 1, further comprising:
a cover member for covering the electric motor and an outer periphery of the shaft,
wherein the seal member includes a first seal member interposed between the cover member and a side surface of the electric motor on a combustion chamber side, and a second seal member interposed between the cover member and the shaft inserting tubular portion.
